(19) United States
(12) Patent Application Publication
(10) Pub. No.: US 2012/0229722 A1
(43) Pub. Date: Sep. 13, 2012

(54) FLEXIBLE SHIELDED DISPLAY

(75) Inventor: Christopher James Newton Fryer, Cambridge (GB)

(73) Assignee: MFLEX UK LIMITED, Cambridge (GB)

(21) Appl. No.: 13/228,622

(22) Filed: Sep. 9, 2011

Related U.S. Application Data
(63) Continuation of application No. PCT/GB2010/050521, filed on Mar. 26, 2010.

(30) Foreign Application Priority Data
Mar. 26, 2009 (GB) 0905214.3

(51) Int. Cl. G02F 1/136

(52) U.S. Cl. 349/41

(57) ABSTRACT

A display comprising a flexible layered structure and a circuit layer. The layered structure comprises an active layer, comprising LC material and electroluminescent/phosphor material, switchable to define information to be displayed sandwiched between front and rear electrodes which are arranged to have an alternating voltage applied thereto to generate an electric field across the active layer. The display further comprises a substrate being the transparent front layer, a reflective insulating layer, an insulating layer mounted behind the rear electrode and a conductive plane mounted behind the insulating layer and connected to ground, to a DC voltage and/or to a same potential as the circuit layer. The circuit layer may comprise at least one switch to be activated by deflection of the layered structure.

### BACKGROUND OF THE INVENTION

1. Field of the Invention

This invention is concerned with flexible displays and, in particular, flexible electroluminescent displays that can be placed over one or more switches such that the switches can be activated by deflection of the electroluminescent display, for example by thumb pressure.

2. Description of the Related Art

It is known to mount a flexible electroluminescent display layer in front of and spaced from a circuit comprising switches such that the switches can be activated by deflection of the electroluminescent display. Such an arrangement is described in International patent application No:PCT/GB2005/000600. However, a problem with this arrangement is that a static charge can build up on the circuit or other elements of the switch and, when the electroluminescent display is driven by an alternating current, the varying potential difference between the rear electrode of the display and the static charge can cause the display to vibrate and, in effect, act like a speaker generating sound. Increasing the rigidity of the electroluminescent display can mitigate this problem. However, a rigid display is not appropriate for use in constructions wherein the display is to be deflected to activate underlying switches.

### SUMMARY OF THE INVENTION

According to a first aspect of the invention there is provided a display comprising a flexible layered structure and, underlying and spaced from the layered structure, a circuit layer, wherein the layered structure comprising an active layer switchable to define information to be displayed sandwiched between front and rear electrodes, the front and rear electrodes arranged have an alternating voltage applied thereto to generate an electric field across the active layer, an insulating layer mounted behind the rear electrode and a conductive plane mounted behind the insulating layer and connected to ground, to a DC voltage and/or to a same potential as the circuit layer.

The display is advantageous as the conductive plane acts as a shield to prevent the formation of an alternating potential difference between the circuit layer and the layered structure that would cause the layered structure to vibrate and potentially generate unwanted sound. However, the conductive plane can be formed as a thin layer such that the layered structure is flexible enough to be deflected as required.

The conductive plane may be patterned to define a continuous layer having a number of cutouts defining areas of increased flexibility. This area may increase the overall flexibility of the layered structure relative to a layered structure without these cutouts.

The layered structure may float above the circuit layer. The display may comprise means for holding the layered structure in place around its periphery.

In a preferred embodiment, the circuit layer comprises at least one switch arranged to be activated by deflection of the layered structure. However, it will be understood that in other embodiments the circuit layer may not comprise mechanically operated switches but deflection of the layered structure may be detected in some other way, for example through capacitance sensing.

The active layer may comprise liquid crystal and/or electroluminescent material.

The layered structure may comprise a mask defining the information to be displayed, an electroluminescent (EL) backlight, the mask comprising a layer of physically-stabilised liquid crystal switchable to define the information to be displayed mounted in front of an EL layer of the backlight, the front and rear electrodes arranged to generate, in use, the electric field across both the EL layer and the LC layer.

The above and other elements, features, steps, characteristics and advantages of the present invention will become more apparent from the following detailed description of the preferred embodiments with reference to the attached drawings.

### BRIEF DESCRIPTION OF THE DRAWINGS

Embodiments of the invention will now be described, by way of illustration only, with reference to the accompanying diagrammatic drawings, in which:

Figures IA to IE show sectional views through different embodiments of displays according to the invention, in open and closed positions;

FIG. 2 shows a sectional view through a layered structure according to one embodiment of the invention

FIG. 3 shows a sectional view through a layered structure according to another embodiment of the invention;

FIG. 4 shows a view of the display from above when activated; and

FIG. 5 shows a plan view of a conductive plane according to an embodiment of the invention.

Figures IA & IB show sectional views through a display comprising a metal dome button switch; in Figure IA the switch is shown open, while in Figure IB it is shown closed by a finger pushing it.

### DETAILED DESCRIPTION OF THE PREFERRED EMBODIMENTS

The switch is of the non latching, or momentary, type, where the momentary (or otherwise) closing of two electrical contacts causes a circuit to be temporarily made. It is of the metal dome variety; it comprises a pressed metal dome (11), with legs (12: usually there are four, but in this section only two can be seen) at the periphery, that is arranged on top of a printed circuit board (PCB 13) so that it is in constant electrical contact with an electrode (14) that is one side of a “broken” electrical circuit (that is, a circuit in which there is a gap (15) across two conductors [14, 16], which gap 15 is to be bridged by the dome 11 when the switch is actuated). When the dome 11 is depressed—as shown in FIG. 1B, by finger pressure (F)—the centre portion 11 is deflected down and brought into contact with the other side 16 of the broken electrical circuit, bridging the gap 15 between the two electrodes 14, 16 and so completing the circuit for as long as the dome 11 is held deflected. And because the dome 11 is made of a springy material, when the deflection force F is removed it springs back to its original domed shape, so breaking electrical contact between the two parts 14, 16 of the electrical circuit.

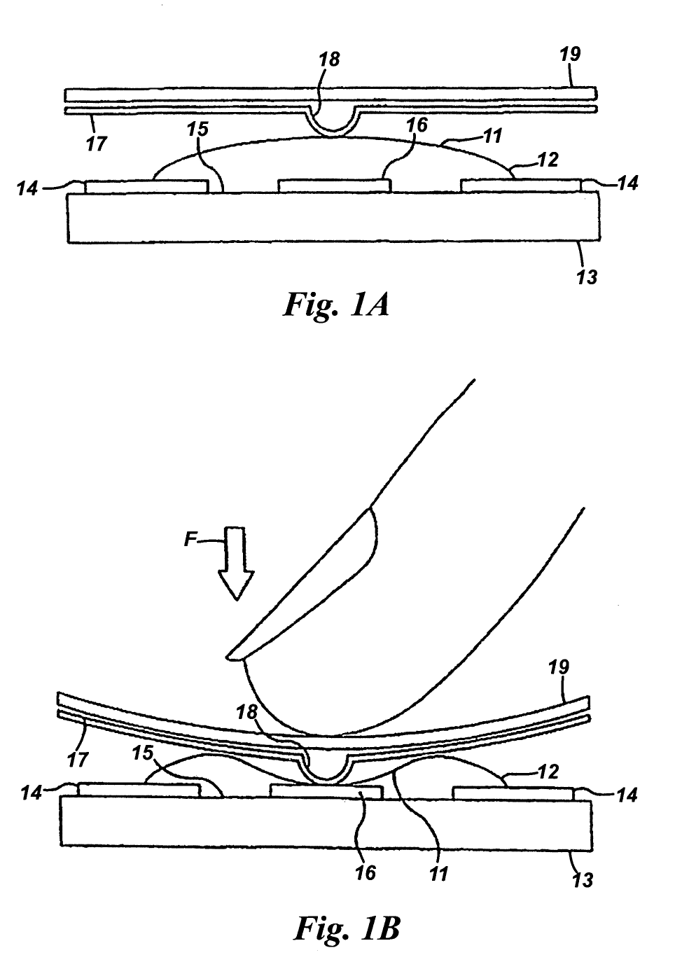

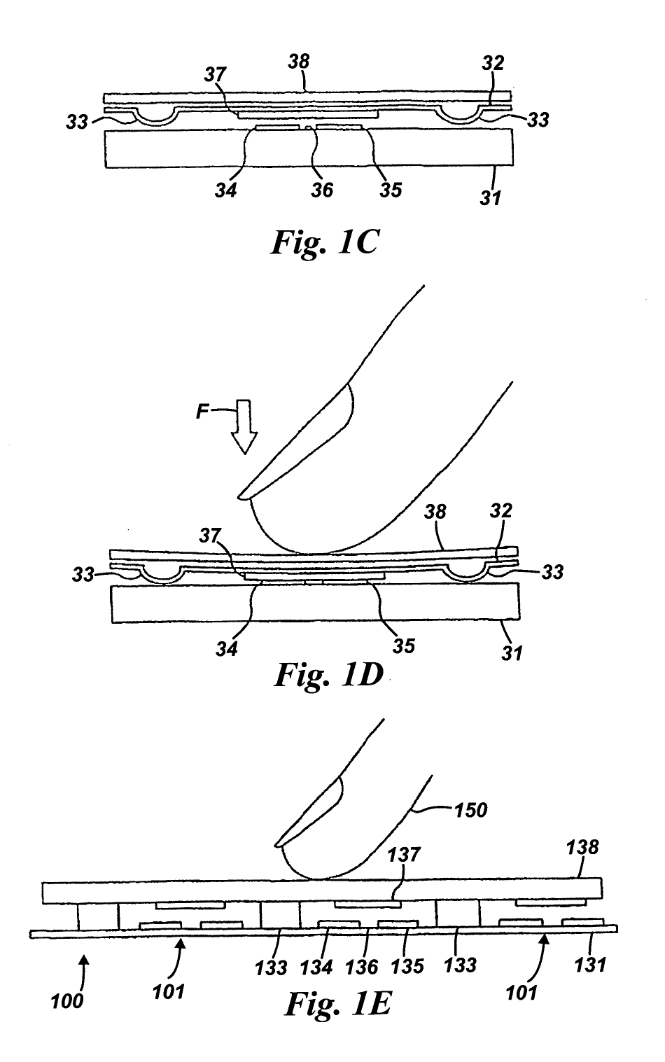

The button as shown uses a force concentration layer (17) laid over the dome 11 to reduce the force needed to deflect the dome. This layer 17 bears a pimple (18) that bears on the dome 11, and so ensures that all the force F provided by finger pressure is actually concentrated on, and applied to, the dome. Overlying the button construction is a layered structure of an electroluminescent display layer (19) as will be described in more detail with reference to FIGS. 2 and 3.

FIGS. 1C & ID show sectional views through display a according to an embodiment of the invention comprising a freely floating button switch, respectively open and closed.

There is shown a push, or button, switch of the non latching, momentary, type. The switch comprises an underlying circuit layer (PCB 31), a resiliently-deformable floating contact layer (32), mounted to face the circuit layer's circuit face, and spacing means (33) that keep the two layers 31,32 apart in the absence of any applied force (F) pushing them together. This switch is now described in more detail as though it were on its own; however, in a real situation this switch would be merely one of an array of like switches, each of which can be operated independently of all the others.

The PCB circuit layer 31 carries the circuit which the switch is to operate. The circuit is not fully shown here, but has two spaced electrodes (34, 35) defining a gap (36) which the switch is to close. The contact layer 32, mounted to face the circuit layer's circuit face, carries on its face toward the circuit a conductive bridge portion (37) aligned with the gap. The bridge portion 37 can be pushed (by force F) into operative contact with the electrodes 34,35 of the circuit layer 31 so as to close the gap 36. The spacing means 33 keeps the two layers 31, 32 apart—and thus the gap 36 unbridged, and so the circuit “open”—in the absence of any applied force F pushing them together.

The contact layer 32 may be made by a thermoforming operation on a single layer of material, to provide both spacing and electrical contacts in one piece. It is manufactured from a thermoplastic film, typically around 0.175 mm thick. On one surface the film is printed with electrically-conductive paste (a silver- or carbon-loaded polymer binder), in a bridge pattern 37 that will in use align with the electrode contact areas 34, 35 laid out on the PCB 31. The film is then thermoformed to provide small ridges 33 around the contact area—in an array of like switches these would be between adjacent contact areas. These ridges form spacers, so that when the contact layer film 32 is resting on the PCB 31 the film's conductive bridge part(s) 37 are not in contact with the PCB's contact areas 34, 35.

The degree of deformation required by thermoforming material of the contact layer 32 in order for it to act as an adequate spacer is related to the material thickness and to the desired spacing between the buttons. Typically, however, it is of the order of the thickness of the material itself (thus, around 0.175 mm).

In this construction, which is in accordance with the invention, the contact layer 32 is also the spacer layer, thus saving not only an entire manufacturing operation but also the adhesive component necessary in the traditional construction of a film keyboard.

Figure ID shows the button of the invention being pressed and making contact between the two circuit elements 34, on the PCB 31. It is important to note that the contact layer floats in the “sandwich” structure depicted, and is not rigidly adhered to either the PCB 31 or to a display layer (38) comprising a layered structure of an electroluminescent display layer positioned above the contact layer. The electroluminescent display layer 38 is in accordance with that described with respect to FIGS. 2 and 3. This floating means that there is avoided the detrimental increase in stiffness that would result from laminating (bonding) the display layer 38 to the contact layer 32, and then gluing the assembly to the PCB 31, which stiffness would render the buttons very difficult to press, as the force necessary to close the contacts would be increased beyond what would be practical.

Of course, although the contact layer 32 is not fixed by adhesive in the construction to either the display layer 38 or the PCB layer 31, but is instead allowed to “float” vertically (that is, in button-pushing alignment) between the PCB and the display layers, nevertheless it is held in place horizontally/laterally by some means (not shown here, but it could be, for example, heat stakes, location pins, mating holes in the PCB corresponding to thermoformed lugs in the contact layer, or edge to edge contact), so that the contact bridge areas 37 are always maintained in the correct positions in lateral alignment with the PCB 31.

This novel construction allows the contact layer 32 to deflect minutely in the horizontal plane—laterally—as well as in the vertical plane when pressing force F is applied to the display layer 38, so greatly reducing the actuation force necessary for adequate deflection. This novel construction also allows the thermoformed spacing part 33 of the layer 32 to be as thin as possible, reducing the deflection needed to actuate the button and make contact, and thereby reducing the stress on the display layer 38 due to deformation, and so increasing its performance life, and the ease with which the switch is closed by the User.

Figure IE of the accompanying drawings shows a further embodiment of a switch according to the present invention. Features common to the embodiment shown in FIGS. 1C and ID of the accompanying drawings have been indicated with the same reference numerals, raised by 100.

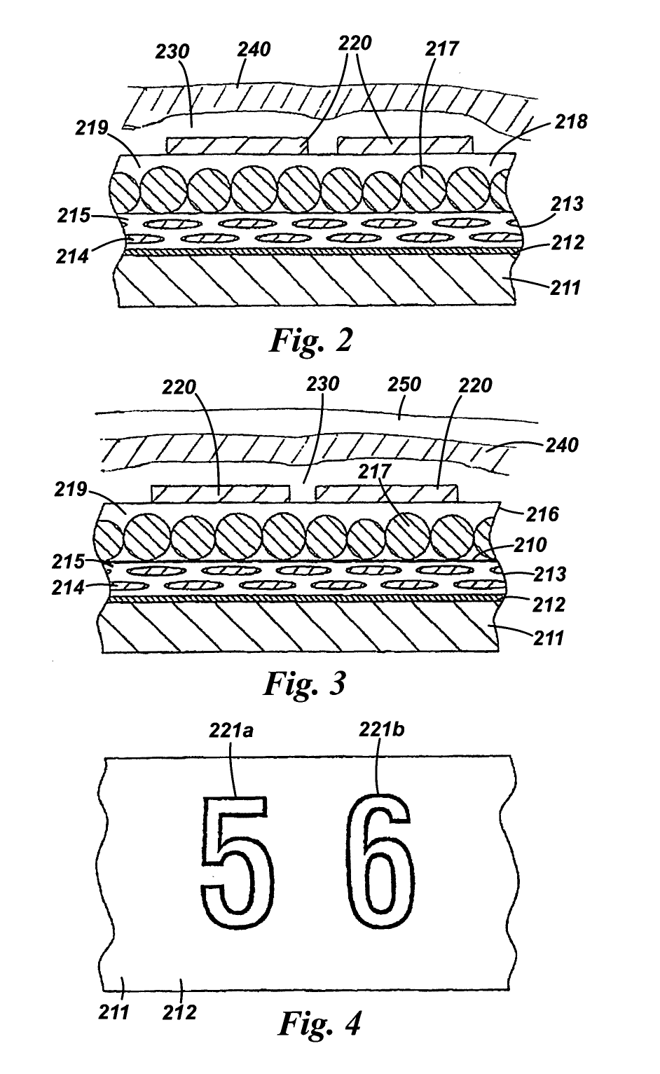

The Figure shows an array 100 of switches 101 sharing a common PCB 131. Each switch 101 (only one of which is referenced in detail in the Figure) comprises as previously a pair of electrodes 134, 135 spaced by a gap 136. Instead of the contact layer 32 of the previous embodiment, the array is provided only with the layered structure of an electroluminescent (EL) display layer 138 which itself performs the functions of the contact layer. This electroluminescent (EL) display layer 138 is formed in accordance with the layered structure described with reference to FIGS. 2 to 5. On this EL layer 138 is printed the conductive bridge portion 137 that can be brought into contact with electrodes 133, 135 to bridge gap 136 on application of pressure by a user 150.

Spacers 133 are provided to keep the bridge portion 137 away from the electrodes 134, 135 when the user 150 is not applying pressure. In this case, the spacers are provided as discrete units, which also serve to fix the EL layer 138 relative to the circuit layer 131. The spacers 133 form a web surrounding the electrodes 134, 135 of each switch 101, so as to describe a mesh. However, the spacers 133 could also comprise an integral part of circuit layer 131 or EL display 138, by printing or forming the appropriate layer with a section which spaces one layer from the other in the absence of pressure on the display 138.

Now referring to FIGS. 2 to 5, the structure of the electroluminescent display layer 19, 38, 138

The structure of the first embodiment of the display of the invention depicted in FIG. 2 of the accompanying drawings can be seen to be, from front to back: a relatively thick protective electrically-insulating transparent front layer (211; the substrate); over the rear face of the substrate 211, a very thin transparent electrically-conductive film (212) forming the front electrode of the display; covering the rear face of the front electrode 212, an active layer comprising a relatively thin layer (213) of LC material (214) physically-stabilised by being dispersed within a supporting matrix (215) and, formed directly on, and covering the rear face of, the liquid crystal layer 213, a relatively thin layer (216) of electroluminescent/phosphor material (217) dispersed within a supporting matrix (218); over the rear face of the phosphor layer 216, a relatively thin optically-reflective electrically-insulating layer (219) of a relatively high dielectric constant material (in the Figure this layer is shown as a seamless extension of the phosphor layer 216); and disposed over the rear face of the reflective electrically-insulating layer 219, an electrically-conductive film (220) forming the rear electrode(s) of the display.

The front and rear electrodes together define which areas of both the liquid crystal layer and the electroluminescent layer can be selected to be switched “on” or “off”.

In an alternative embodiment shown in FIG. 3 of the accompanying drawings, the EL and LC materials are not directly formed on one another, but are instead separated by an insulating interlayer 210. In all other aspects, the embodiments are the same and common reference numerals have been used.

In both embodiments, the rear electrode layer 220 is covered with a protective insulating film 230 and over this protective insulating film is printed a conductive plane 240. A further insulating layer 250 (shown in FIG. 3) may be printed over the conductive plane 240.

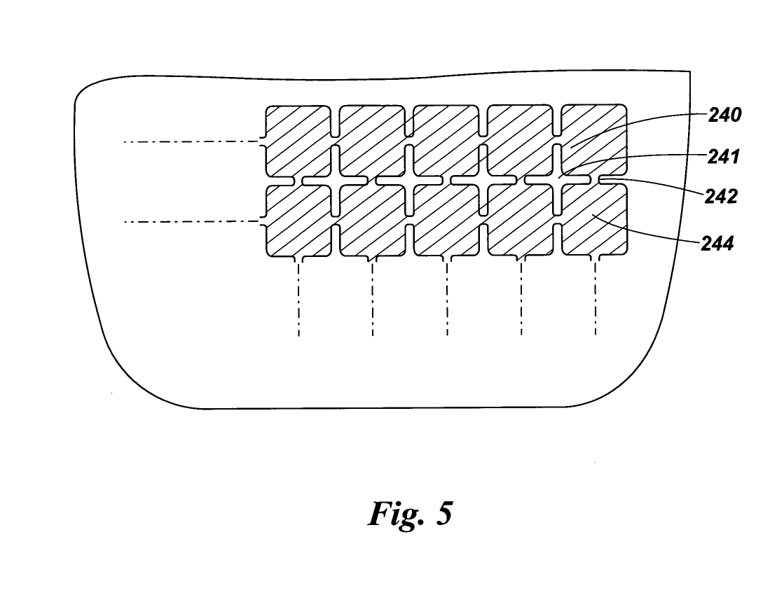

Referring to FIG. 5, the conductive plane 240 may be patterned to define a continuous layer having a number of cutouts 241 defining areas of increased flexibility. In this embodiment, the cut-outs 241 are cross-shaped to define large segments 244, in this embodiment rectangular segments, of the conductive plane 240 connected by relatively narrow bridges 242 to electrically connect the large segments 244 together. By having a patterned conductive plane 240 areas 241 of increased flexibility (and therefore reduced rigidity) are created to ensure that the electroluminescent display layer can flex as required to operate the switches. The conductive plane 240 is typically a few microns to tens of micros thick. A thin conductive plane 240 is desirable to maintain a flexible display layer.

In this embodiment, the conductive plane 240 is connected to ground. However, it will be understood that the conductive layer 240 may be connected to a DC voltage, to the same potential as the circuit layer, metal dome 11, contact layer 32 or any other source of a potential of a few volts. In order that the conductive plane 240 acts as shield to prevent large potential differences developing between the rear electrode 220 and the button it is simply necessary to connect the conductive plane 240 to ground or to a potential of a few volts, which is much less than the hundreds of volts that appear on the rear electrode when the electroluminescent display layer is driven by an alternating high voltage.

In other embodiments, the active layer is just a liquid crystal layer, such as a PDLC layer, just an EL layer or a layer of another light emitting substance activated by an alternating electric field.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A display comprising:
a flexible layered structure including:
front and rear electrodes;
an active layer arranged between the front and rear electrodes and arranged to be switchable to define information to be displayed;
an insulating layer arranged behind the rear electrode; and
a conductive plane arranged behind the insulating layer; and
a circuit layer arranged behind and spaced away from the flexible layered structure; wherein
the front and rear electrodes are arranged to apply an electric field across the active layer; and
the conductive plane is connected to at least one of a ground, a DC voltage, and a same potential as the circuit layer.

2. A display according to claim 1, wherein the conductive plane includes cutouts.

3. A display according to claim 2, wherein the cutouts are cross-shaped.

4. A display according to claim 1, wherein the flexible layered structure floats above the circuit layer.

5. A display according to claim 4, further comprising at least one of heat stakes, location pins, and mating holes with corresponding lugs arranged to hold the flexible layered structure in place around its periphery.

6. A display according to claim 1, wherein the circuit layer includes at least one switch arranged to be activated by deflection of the flexible layered structure.

7. A display according to claim 1, wherein the active layer includes at least one of a liquid crystal material and an electroluminescent material.

8. A display according to claim 1, wherein:
the active layer includes:
an electroluminescent backlight including an electroluminescent layer; and
a mask mounted in front of the electroluminescent layer and including a physically-stabilised liquid crystal layer arranged to be switchable to define the information to be displayed; and
the front and rear electrodes are arranged to apply the electric field across both the electroluminescent layer and the physically-stabilised liquid crystal layer.
